(19) United States
(12) Patent Application Publication
(10) Pub. No.: US 2025/0333094 A1
(43) Pub. Date: Oct. 30, 2025

(54) TRAY APPARATUS FOR USE WITH STROLLER/WAGON

(71) Applicant: WonderFold Corporation, Irwindale, CA (US)

(72) Inventors: Sze Wah Ng, Irwindale, CA (US); Yumei Xiang, Irwindale, CA (US)

(21) Appl. No.: 18/793,653

(22) Filed: Aug. 2, 2024

(30) Foreign Application Priority Data
Apr. 24, 2024 (CN) 202430234149.0

(51) Int. Cl. B62B 9/26

(52) U.S. Cl. CPC B62B 9/26

(57) ABSTRACT

A tray apparatus for use with a vehicle is presented. The tray apparatus includes a base and two sides, a plurality of vehicle connectors affixable to the two sides and configured to attach to the vehicle and maintain the base and two sides within the vehicle, and a reversible holder including a holder top and a plurality of holder sides, the reversible holder configured to fit with the base and two sides at a first position inside the vehicle and additionally fit over one vehicle connector at a second position outside the vehicle.

### BACKGROUND

The present application claims priority based on Chinese Patent Application No. Application number: 202430234149.0, filed Apr. 24, 2024, entitled TROLLEY DINING TRAY, inventors Sihua Wu and Yumei Xiang, the entirety of which is incorporated herein by reference.

### I. FIELD

The present invention relates to the field of accessories used with carriers, and more specifically to accessories used with wagons and stroller type devices.

### II. BACKGROUND

The fields of wagons and strollers have expanded into combined wagons and strollers, enabling children and other items to be transported therein with an adult able to push or pull the wagon/stroller. Transporting the child or children for long periods of time presents certain logistical issues.

Adults will attempt to keep children entertained when employing strollers or wagons, and in many instances provide children with food, drinks, or other items to keep the children fed, hydrated, and/or occupied. In situations where the stroller or wagon is being transported around a location such as a swap meet, carnival, farmer's market, street fair, or other event, children may receive food or drinks. In previous wagons, the child may have had no receptacle or tray for the food or drink, and may have had to hold the food or drink which is inconvenient and can result in spills.

Many strollers are equipped with food trays and some have cup indentations or cutouts for the child to hold food and drink. However, such trays are generally fixed or provided in a fixed position but can be removed or repositioned. For example, such trays may be rotated for the child to enter and exit the stroller. Such trays can take up significant space and are not practical for use in devices such as wagons or combination wagon/strollers. Strollers are typically used for very young children, and older children are typically not transported in strollers.

Wagon type devices that can be used to transport infants, toddlers, and older children present challenges in that a fixed tray or cupholder. A tray located at a fixed location in the wagon can be either inconvenient or can inhibit movement and/or storage within the wagon. Further, if the wagon can be configured differently, such as moving the seats or altering components in the wagon, fixing a tray or surface or cupholder can be inconvenient and generally disadvantageous. The child, children, or items stored may inhibit enjoyment of the wagon and a fixed position tray may get in the way of normal use of the wagon.

Additionally, wagons can be used to carry items of various sizes in addition to children, but none of these types of vehicles offer the ability to provide food and drink access either inside the wagon when space permits or outside the wagon when many items are being transported.

It would therefore be beneficial to provide a wagon/stroller accessory design, such as a food or cup holder, that overcomes issues with prior wagon and stroller designs.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

According to one embodiment, there is provided a tray apparatus for use with a vehicle comprising a base and two sides, a plurality of vehicle connectors affixable to the two sides and configured to attach to the vehicle and maintain the base and two sides within the vehicle, and a reversible holder comprising a holder top and a plurality of holder sides, the reversible holder configured to fit with the base and two sides at a first position inside the vehicle and additionally fit over one vehicle connector at a second position outside the vehicle.

According to another embodiment, there is provided a tray apparatus for use with a vehicle comprising a base and a plurality of sides, a plurality of vehicle connectors each affixable to at least one of the plurality of sides and configured to attach to the vehicle and maintain the base and the plurality of sides within the vehicle, and a reversible holder comprising a holder top and a plurality of holder sides, the reversible holder configured to fit with the base and plurality of sides at a first position inside the vehicle and additionally fit over one vehicle connector at a second position outside the vehicle.

According to a further embodiment of the present design, there is provided a tray apparatus for use with a vehicle comprising a base, a plurality of sides, a plurality of vehicle connectors each affixable to at least one of the plurality of sides and configured to attach to the vehicle, and a reversible holder comprising a holder top and a plurality of holder sides, the reversible holder configured to fit with the base and plurality of sides inside the vehicle. The reversible holder is repositionable to fit over one vehicle connector outside the vehicle.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 illustrates the present design in a desired vehicle environment such as a wagon or combination wagon/stroller,

FIG. 2 is a perspective view of the present design in a first desired configuration;

FIG. 3 is a side view of the design in the first configuration;

FIG. 4 illustrates the present design in a second configuration wherein cup receptacles may be positioned or located outside the sides of the wagon or stroller;

FIG. 5 is a first alternate embodiment of the present design including no flaps;

FIG. 6 shows a side view of the first alternate embodiment; and

FIG. 7 illustrates the first alternate embodiment in a configuration wherein cup receptacles may be positioned or located outside the sides of the wagon or stroller.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

Described embodiments are only some of the embodiments of the present invention, not all of them. If directional indications are provided (such as up, down, left, right, front, back, top, bottom, inner, outer, vertical, transverse, longitudinal, counterclockwise, clockwise, circumferential, radial, axial . . . ), the directional indication is only used to explain the relative positional relationship, movement conditions, etc. When the specific posture changes, the directional indication also changes accordingly.

A description related to “the first” or “the second” etc. in an embodiment are for descriptive purposes only and are not to be construed as indicating or implying their relative importance or implying the number of technical characteristics indicated. Thus, features defined as “first” and “second” may expressly or implicitly include up to one or more fewer features. In addition, the technical solutions of the various embodiments can be combined with each other.

The present design provides an accessory design, typically called a snack tray, that may be employed in a wagon or wagon/stroller type vehicle. The snack tray is adjustable and can be moved and resized to fit within different wagons. The design includes three major components that can be repositioned inside or outside the vehicle or wagon and moved to different locations in the wagon when desired.

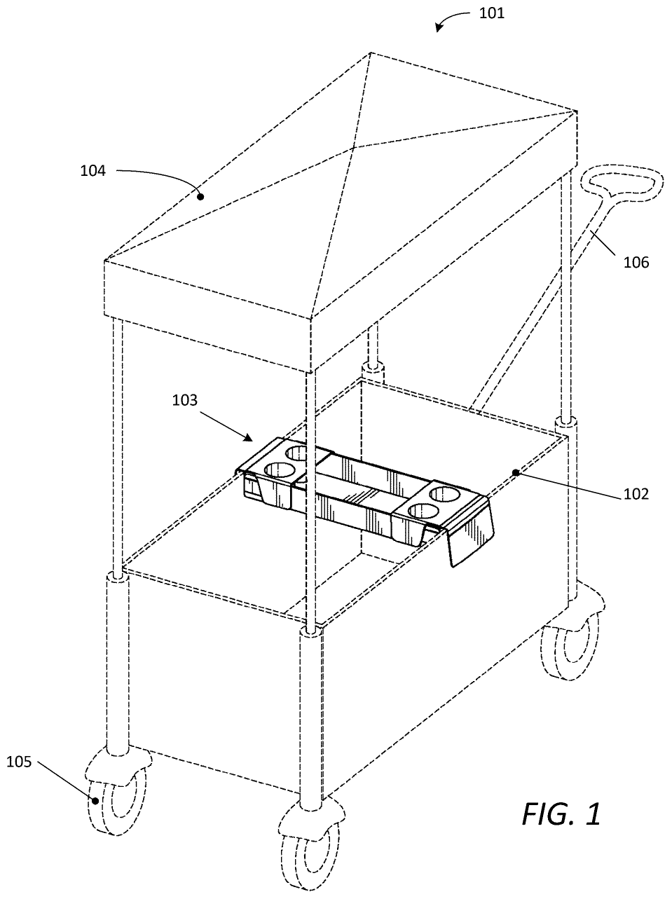

FIG. 1 illustrates an overall view of the present design. Wagon, stroller, vehicle, or combination stroller/wagon 101, referred to as wagon 101 herein, typically has an upper edge 102 and may include an optional canopy 104. In this embodiment, wheels such as wheel 105 are provided such that the wagon 101 can be moved or pushed along the ground or other surface. Also shown in this view is handle 106. Snack tray or accessory 103 is positioned in association with upper edge 102 of wagon 101. Upper edge 102 may be a single bar or a multiple element bar or may simply be the top edge of a solid side or partial side. The bar or edge may be squared or rounded, for example. The components of snack tray 103 fit over different types of wagon edges and typically rest atop upper edge 102. In this configuration, snack tray 103 may be pushed or repositioned forward or rearward along the edges of the stroller/wagon or wagon 101, i.e. toward the front or the rear of wagon 101.

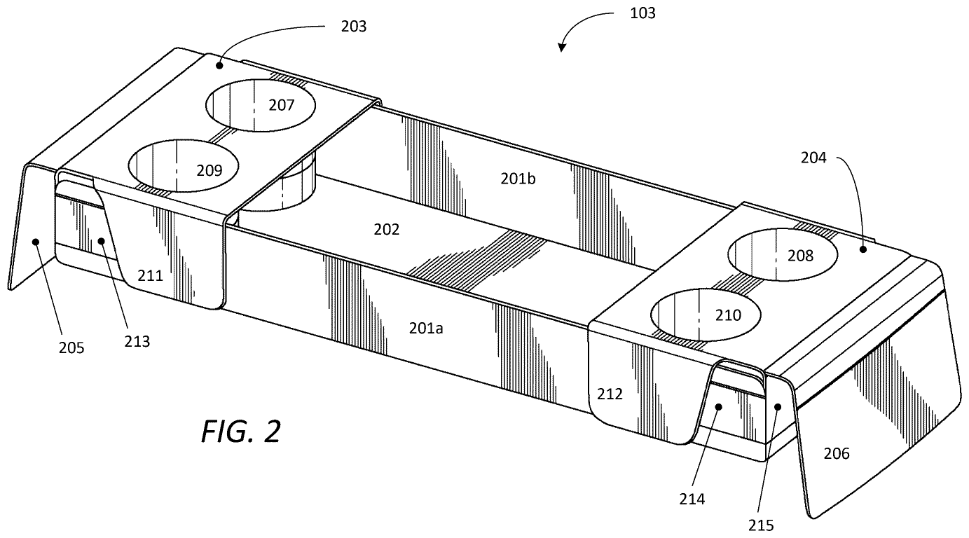

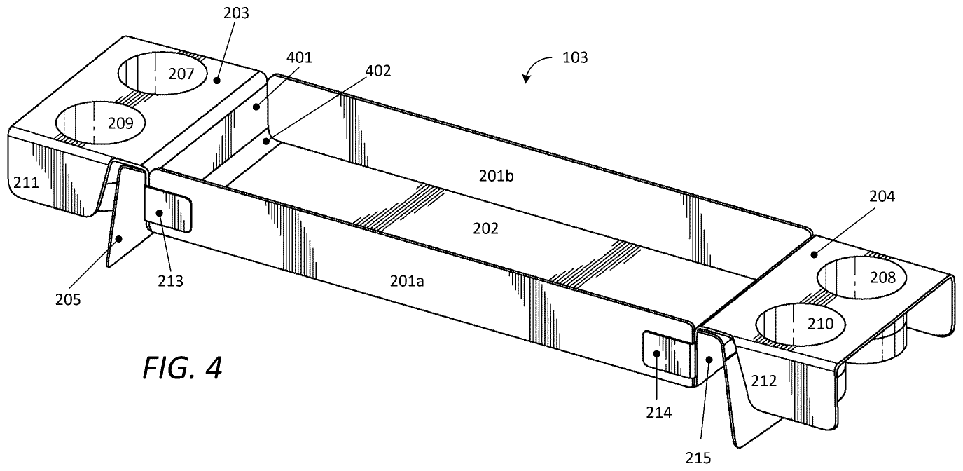

FIG. 2 shows the components of accessory or snack tray 103. Sides 201a and 201b and base 202 are provided typically as a unitary piece. Base 202 provides an opening whereby food or other items may be placed. Holding elements 203 and 204 can be positioned with the edge or edges of the carrier, such as a wagon and can be moved to correctly size and position snack tray 103. Holding elements 203 and 204 include tops, sides, and an attachment or side element. Side elements such as side element 205 are provided and are typically joined to holding element 203. Holding element side 211 and side element 205 may be integrally formed with the holding element 203. In this embodiment side element 205 is formed separately from holding element 203. As shown in FIG. 4 side element 205 may be joined to or formed with sides 201a and 201b and/or base 202.

Holding element 203 includes openings 207 and 209 formed therein which may receive cups or other items (juice boxes, bags of food, etc.) Openings 207 and 209 may include, for example, cylindrical elements below the top surface of holding element 203 or may simply comprise openings allowing cups to pass through each opening with no further below-surface hardware or components. Cups placed in openings 207 and 209 when formed with no hardware or components beneath may contact base 202. Similar openings may be provided on holding element 204, including openings 208 and 210. While openings 207, 208, 209, and 210 are shown with circular openings here, other shaped and dimensioned openings may be provided, or may be omitted if desired. Holding element 204 also includes side element 206 and holding element side 212. Companion holding element sides are provided on the opposite sides of both holding elements 203 and 204 in this embodiment and are not shown in FIG. 2.

In this embodiment, sides 201a and 201b receive holding elements 203 and 204 as shown. Sides 201a and 201b may include connections 213 and 214 which may enable affixation of side elements 205 and 206 to sides 201a and 201b. Alternately or in addition, connections 213 and 214 may comprise tracks or ridges that enable the fixation and movement of the sides along the tracks or ridges, wherein the holding element sides 211 and/or 212 include complimentary receiving tracks or ridges on the inside thereof, facilitating sliding of holding elements 203 and 204.

Sides 201a and 201b and base 202 may either be U-shaped, i.e., open, when viewed from the end or the ends may be closed, with a wall or surface provided at one or both ends. In one embodiment walls or surfaces are integrally formed with sides 201a and 201b and base 202. A rear surface such as rear surface 215 may be provided wherein when the sides 201a and 201b of base 202 form a U-shape with open ends. Rear surface 215 may assist in keeping items from spilling out into the wagon or stroller 101.

In operation, holding elements 203 and 204 in combination with sides 201a and 201b and base 202 provide a stable platform for maintaining desired items, one that is movable and locatable within different positions in different types of wagons. The resultant apparatus is removable and not locked firmly in one position in the wagon or vehicle. Tracks or ridges 213 and 214 when provided can provide additional stability.

The components of FIG. 2 may be fabricated from any appropriate material, including but not limited to hard plastic, metal, polymers, or even wood or rubberized materials. Different materials may be used for different components. For example, sides 201a and 2016 and base 202 may be formed of metal while holding elements 204 and 205 may be formed of a hard plastic. The foregoing is not intended to be in any way limiting, and any appropriate material may be employed for any of the components shown in the enclosed drawings.

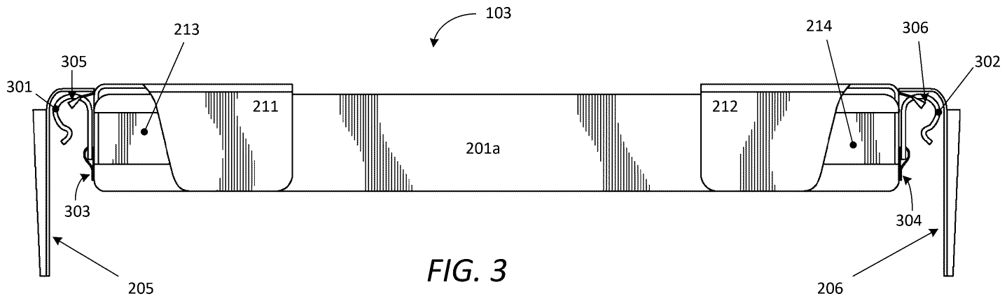

FIG. 3 is a side view of one embodiment of the present design. From FIG. 3, internal clips 301 and 302 are provided to receive the edges of the wagon which may be rounded. Holding clips 303 and 304 secure internal clips 301 and 302 to the rear surfaces, such as rear surface 215. Holding elements 305 and 306 may be provided to maintain internal clips 301 and 302, as the internal clips may move or become unstable and/or difficult to attach to a wagon. Holding elements may be formed of any suitable material, including metal, fabric, fiber, or other appropriate material.

FIG. 4 illustrates an alternate orientation of the present design. Conceptually, sides 201a and 201b and base 202 are the same, with side elements 205 and 206 provided with sides 201a and 201b and held in place using connections 213 and 214. Rear surface 215 is shown and remains in the same position. In this orientation, holding elements 203 and 204 have been repositioned such that when side elements 205 and 206 are attached to wagon 101, the side elements 205 and 206 are on the outside of wagon 101, including openings 207, 208, 209, and 210 for receiving cups, etc. In this manner, more space can be provided in wagon 101, more of base 202 is available, and cups and other items can be located in openings 207, 208, 209, and 210 and accessible to persons in wagon 101.

In the configuration of FIG. 4, holding elements 204 and 205 may be joined to surfaces such as rear surface 215 by pressure, by affixation devices such as Velcro, snaps, clips, or other devices, or may be sized to solidly or firmly fit with side elements 205 and 206 for example. In the present embodiment, rear holding element wall 401 may fit within a receiving element 402, which as shown in FIG. 4 is a curved element sized and positioned to receive rear holding element wall 401. In one embodiment, holding elements 204 and 205 including rear holding element wall 401 may be formed of hard plastic, while receiving element 402 may be formed of a hard rubber material. A locking element or arrangement may be provided such as Velcro, snaps, pins, or other element or elements to maintain holding elements 204 and 205 in place.

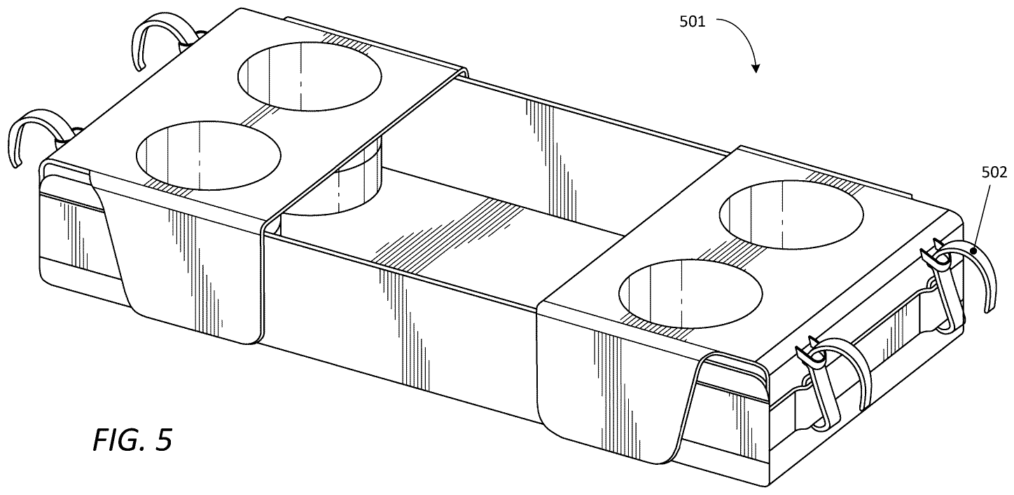

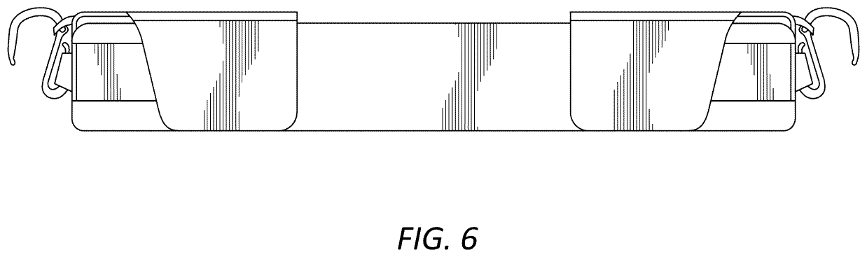

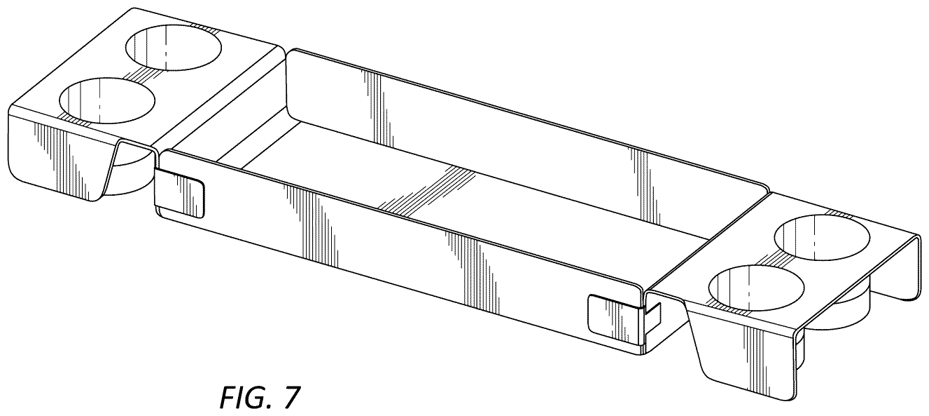

FIG. 5 illustrates a first alternate embodiment of the present design without the flaps shown in FIGS. 1 through 4. Hooks are provided such as hook 501 to attach the tray to the stroller or wagon. FIG. 6 is a side view of this first alternate embodiment, and FIG. 7 is a representation of the first alternative embodiment with the cup holders positioned to be located outside the stroller or wagon. The clips in the present design may differ from those shown in the present drawings, including in all of FIGS. 1 through 7. Such clips provide secure attachment of the tray to the wagon, such as attachment to the tops of the sides of the wagon or stroller.

Thus according to one embodiment, there is provided a tray apparatus for use with a vehicle comprising a base and two sides, a plurality of vehicle connectors affixable to the two sides and configured to attach to the vehicle and maintain the base and two sides within the vehicle, and a reversible holder comprising a holder top and a plurality of holder sides, the reversible holder configured to fit with the base and two sides at a first position inside the vehicle and additionally fit over one vehicle connector at a second position outside the vehicle.

According to another embodiment, there is provided a tray apparatus for use with a vehicle comprising a base and a plurality of sides, a plurality of vehicle connectors each affixable to at least one of the plurality of sides and configured to attach to the vehicle and maintain the base and the plurality of sides within the vehicle, and a reversible holder comprising a holder top and a plurality of holder sides, the reversible holder configured to fit with the base and plurality of sides at a first position inside the vehicle and additionally fit over one vehicle connector at a second position outside the vehicle.

According to a further embodiment of the present design, there is provided a tray apparatus for use with a vehicle comprising a base, a plurality of sides, a plurality of vehicle connectors each affixable to at least one of the plurality of sides and configured to attach to the vehicle, and a reversible holder comprising a holder top and a plurality of holder sides, the reversible holder configured to fit with the base and plurality of sides inside the vehicle. The reversible holder is repositionable to fit over one vehicle connector outside the vehicle.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A tray apparatus for use with a vehicle comprising:
a base and two sides;
a plurality of vehicle connectors affixable to the two sides and configured to attach to the vehicle and maintain the base and two sides within the vehicle; and
a reversible holder comprising a holder top and a plurality of holder sides, the reversible holder configured to fit with the base and two sides at a first position inside the vehicle and additionally fit over one vehicle connector at a second position outside the vehicle.

2. The tray apparatus of claim 1, further comprising an additional reversible holder comprising an additional holder top and a plurality of additional holder sides, the additional holder configured to fit with the base and two sides at an initial position inside the vehicle and additionally fit over a second vehicle connector at a further position outside the vehicle.

3. The tray apparatus of claim 1, wherein the holder top comprises at least one opening formed therein.

4. The tray apparatus of claim 3, further comprising one holding apparatus below each of the at least one openings.

5. The tray apparatus of claim 1, wherein the vehicle comprises a wagon comprising a left side and a right side, and one vehicle connector attaches to the left side and a second vehicle connector attaches to the right side.

6. The tray apparatus of claim 1, wherein each vehicle connector is formed with a plurality of side tabs connecting each vehicle connector to the two sides.

7. The tray apparatus of claim 5, wherein one vehicle connector comprises a holding clip fittable over one of the left side and the right side.

8. A tray apparatus for use with a vehicle comprising:
a base and a plurality of sides;
a plurality of vehicle connectors each affixable to at least one of the plurality of sides and configured to attach to the vehicle and maintain the base and the plurality of sides within the vehicle; and
a reversible holder comprising a holder top and a plurality of holder sides, the reversible holder configured to fit with the base and plurality of sides at a first position inside the vehicle and additionally fit over one vehicle connector at a second position outside the vehicle.

9. The tray apparatus of claim 8, further comprising an additional reversible holder comprising an additional holder top and a plurality of additional holder sides, the additional holder configured to fit with the base and plurality of sides at an initial position inside the vehicle and additionally fit over a second vehicle connector at a further position outside the vehicle.

10. The tray apparatus of claim 8, wherein the holder top comprises at least one opening formed therein.

11. The tray apparatus of claim 10, further comprising one holding apparatus positioned below each of the at least one openings.

12. The tray apparatus of claim 8, wherein the vehicle comprises a wagon comprising a left side and a right side, and one vehicle connector attaches to the left side and a second vehicle connector attaches to the right side.

13. The tray apparatus of claim 8, wherein each vehicle connector is formed with a plurality of side tabs connecting each vehicle connector to the two sides.

14. The tray apparatus of claim 12, wherein one vehicle connector comprises a holding clip fittable over one of the left side and the right side.

15. A tray apparatus for use with a vehicle comprising:
a base;
a plurality of sides;
a plurality of vehicle connectors each affixable to at least one of the plurality of sides and configured to attach to the vehicle; and
a reversible holder comprising a holder top and a plurality of holder sides, the reversible holder configured to fit with the base and plurality of sides inside the vehicle;
wherein the reversible holder is repositionable to fit over one vehicle connector outside the vehicle.

16. The tray apparatus of claim 15, further comprising an additional reversible holder comprising an additional holder top and a plurality of additional holder sides, the additional holder configured to fit with the base and plurality of sides at an initial position inside the vehicle and additionally fit over a second vehicle connector at a further position outside the vehicle.

17. The tray apparatus of claim 15, wherein the holder top comprises at least one opening formed therein.

18. The tray apparatus of claim 15, wherein the vehicle comprises a wagon comprising a left side and a right side, and one vehicle connector attaches to the left side and a second vehicle connector attaches to the right side.

19. The tray apparatus of claim 15, wherein each vehicle connector is formed with a plurality of side tabs connecting each vehicle connector to the two sides.

20. The tray apparatus of claim 18, wherein one vehicle connector comprises a holding clip fittable over one of the left side and the right side.
